(19) United States
(12) Patent Application Publication
(10) Pub. No.: US 2014/0301423 A1
(43) Pub. Date: Oct. 9, 2014

(54) METHOD FOR OPERATING ARC FURNACE

(71) Applicant: SIEMENS AKTIENGESELLSCHAFT, München (DE)

(72) Inventors: Arno Döbbeler, Herzogenaurach (DE); Klaus Krüger, Hamburg (DE); Thomas Matschullat, Eckental (DE)

(21) Appl. No.: 14/355,787

(22) PCT Filed: Oct. 25, 2012
(86) PCT No.: PCT/EP2012/071107

§ 371 Date: May 1, 2014

(30) Foreign Application Priority Data
Nov. 3, 2011 (EP) 11187639.7

(51) Int. Cl. H05H 1/34; H05B 7/20

(52) U.S. Cl. CPC H05H 1/34; H05B 7/20
USPC 373/25; 373/88; 219/121.55

(57) ABSTRACT

A material is melted in an arc furnace by a plasma arc produced by at least one electrode. The plasma arc is regulated by one or more additional substances which influence the plasma composition introduced into the plasma, increasing the efficiency and output of the arc furnace.

### CROSS REFERENCE TO RELATED APPLICATIONS

This application is the U.S. national stage of International Application No. PCT/EP2012/071107, filed Oct. 25, 2012 and claims the benefit thereof. The International Application claims the benefit of European Application No. 11187639 filed on Nov. 3, 2011, both applications are incorporated by reference herein in their entirety.

### BACKGROUND

Described below is a method for operating an arc furnace, in particular an electric arc furnace, having at least one electrode, wherein a melting material is melted in the arc furnace by a plasma arc produced by the at least one electrode. In this case, “melting material” is understood as a solid material, liquid metal and/or even slag to be melted. The application further relates to a signal processing device for an arc furnace, a machine-readable program code for a signal processing device for an arc furnace as well as a storage medium with such a machine-readable program code stored therein. The application finally relates to an arc furnace, in particular an electric arc furnace, having such a signal processing device.

An arc furnace serves for producing liquid metal, generally steel. The liquid metal is produced from a solid melting material, namely scrap or reduced iron, together with further additional materials. To this end, at the start of the process the arc furnace is charged with scrap and/or reduced iron and then plasma arcs are ignited between electrodes of the arc furnace and the melting material. The energy introduced by the plasma arc into the arc furnace results in the melting of the remaining melting material. Such arc furnaces are disclosed, for example, in the published patent applications DE 0 122 910 A1, DE 41 30 397 A1 and EP 0 292 469 A1.

The electrical connection power of arc furnaces is continually increasing. Whilst in the 1980s 100 MVA was still regarded as a peak value, the typical power of new furnaces today is in the order of 150 MVA. Even arc furnaces having a connection power of more than 200 MVA are occasionally in operation. In principle, high connection powers are attractive as they permit high productivity with low specific personnel and investment costs.

High melting outputs are associated with high arc currents and, in particular, with high arc voltages. The associated long and high-powered arcs represent a considerable challenge for controlling the process. At all times the arcs have to be surrounded by sufficient scrap and/or foaming slag in order to permit an efficient introduction of energy and to prevent damage to the furnace vessel. Accordingly, it is necessary to react rapidly to a meltdown of the scrap or a break-up of the foaming slag by a marked reduction of the arc length and thus the melting output. In particular, for example during the production of stainless steel, it is only possible to work at reduced arc power due to the absence of foaming slag, in the case of a liquid bath.

A further increase in the output of three-phase AC arcs and DC arcs appears to be almost impossible by increasing the voltage, due to the resulting long arcs. Reasons for not increasing the output via the current are the resulting high supply line losses and limitations to the equipment, such as for example the electrodes.

When melting the scrap material, the scrap movements and the variable plasma conditions in the arc lead to considerable current fluctuations. These current fluctuations cause interruptions to the power supply network which are described by the so-called flicker value. With a given grid short-circuit power, the flicker value increases proportionally with the furnace output.

Hitherto, the aforementioned difficulties were met in different ways. The melting output is, for example, automatically adapted to the current process conditions, in the simplest case this takes place via thermally based output controls, as is described in Dorndorf, M., Wichert, W, Schubert, M., Kempken, J., Krüger, K.: Holistic Control of EAF's Energy and Material Flows. 3rd International Steel Conference on New Developments in Metallurgical Process Technologies, Düsseldorf, 11-15.06.2007, p 513-520.

Recently, the melting output has also been adapted to the current process conditions via an output control based on structure-borne sound, see Dittmer, B., Krüger, K., Rieger, D., Matschullat, T., Döbbeler, A.: Asymmetrical Power Control of AC-EAFs by Structure-Borne Sound Evaluation, Iron & Steel Technology Conference 2010, Pittsburgh, 3-6 May 2010, p 937-946.

In principle, by using these controls, excessive wear of the furnace vessel is avoided but production sections with, in some parts, a considerably reduced melting output have to be taken into account. Moreover, the injection of fine coal and thus the formation of foaming slag is automatically controlled, see Homeyer, K.: Automation of the Addition of Coal for the Formation of Foaming Slag in Arc Furnaces, Dr.-Ing. Dissertation, University of the Federal Armed Forces Hamburg (2000), VDI-Research Reports, Series 8, no. 862, VDI-Publications [VDI—Verein Deutscher Ingenieure (Association of German Engineers], Düsseldorf 2001 and Matschullat, T., Wichert, W, Rieger, D: Foaming Slag in More Dimensions—A New Detection Method with Carbon Control, AISTech 2007, Indianapolis 7-10 May 2007.

Finally, it is possible to cite attempts to create such a thing as foaming slag, even in stainless steel production, see Reichel, J., Rose, L., Cotchen, J. K., Damazio, M. A., Loss, H. B., Pinto E. M.: EAF Foamy Slag in Stainless Steel Production: Industrial Experiences and Further Development, Iron & Steel Technology Conference 2010, Pittsburgh, 3-6 May 2010, p 793-799.

With the successful formation of foaming slag, which is not guaranteed per se, in principle a melting operation at high power is possible even during the liquid bath phase. To limit the flicker value in high-powered arc furnaces, respectively in the case of weak power supply networks, the installation of a dynamic reactive power compensation system is required. However, even with such systems, a maximum of a five-times reduction of the flicker value is possible.

### SUMMARY

The method described below results in an increase in the efficiency and power of an arc furnace having at least one electrode. A melting material is melted in the arc furnace by a plasma arc produced by the at least one electrode and wherein the plasma arc is controlled by an additional substance, which influences the plasma composition, being introduced into the plasma. In this case, for reducing the field strength of the plasma arc at least one additional substance with low ionizing energy, in particular a metal or a metal salt, is introduced into the plasma and for increasing the field strength of the plasma arc at least one additional substance with high ionizing energy, in particular an inert gas, is introduced into the plasma.

In this case, “plasma composition” is understood in particular as a plasma atmosphere. The properties of the plasma in this case depend on the plasma composition.

Hitherto, it had been assumed that the composition of the arc plasma is predetermined by the process. In this case, the current plasma composition determines the stability and the combustibility of the arc. Thus, during the melting process it has considerable influence on the flicker behavior.

The method is based on introducing different additional substances, in particular gases, but also solid particle aerosols and/or dusts, in a controlled manner into the arc plasma in order to adapt the properties of the plasma arc in a targeted and dynamic manner to the current process requirements. In this case, the additional substances are fed, in particular directly, into the plasma and act directly on the plasma and alter its physical and/or chemical properties, such as for example its ionizability, recombination time, conductivity and/or field strength. The behavior of the plasma is able to be specifically adjusted both by the type and the proportion of additional substance(s) introduced into the plasma. The effect of the plasma composition and thus the properties of the plasma arc may be used both in DC arcs and three-phase AC arcs. Also, controlling the conductivity of the plasma arc is also applicable in ladle furnaces. A specific adjustment of the conductivity and/or the field strength of the plasma arc is also transferable to special melting systems, such as electric submerged arc furnaces.

A starting point is a constant arc current which is adjusted by a corresponding control. The arc output is in this case directly proportional to the product of the arc length, the field strength of the arc and the arc current. If the arc current is constant, therefore, the field strength and/or the arc length may be varied in order to achieve a desired output. By modifying the plasma atmosphere, the field strength may be adjusted in a defined manner.

The increase in the melting output of the plasma arc by the targeted modification of the plasma is synonymous with a stepless adaptation of the properties of the plasma to the current plasma conditions, whereby consistent arc operation is implemented with a high and efficient output.

To reduce the field strength (and/or to increase the conductivity) of the plasma arc, an additional substance with low ionizing energy, in particular a metal or metal salt, is introduced into the plasma. Suitable for increasing the conductivity and extending the recombination time of the charge carrier in the plasma of the arc are, for example, lithium, sodium, potassium and aluminum as metals or corresponding salts. For starting up and for scrap melting and/or generally in the case of an inconsistent melting operation, the plasma is modified such that it is able to be ionized easily, slowly recombined and has high conductivity and/or low field strength. A plasma with high conductivity and low field strength is advantageous primarily in scrap melting i.e. when the solid material component in the arc furnace is high. By including the additional substance, the arc is stabilized and the flicker value is reduced. In this case, a high volume of scrap is melted.

To increase the field strength (and/or for reducing the conductivity) of the plasma arc, in turn an additional substance with high ionizing energy, in particular an inert gas, is introduced into the plasma. In particular, for operation on a liquid bath, the plasma is modified so that it has low conductivity and/or high field strength. This takes place, for example, by the injection of helium or argon. Alternatively, hydrogen and/or hydrogen-containing gases, such as propane, nitrogen and oxygen and/or carbon monoxide or carbon dioxide are also suitable for this application. The resulting short arcs are associated with a lower radiation load for the furnace wall. In this case, high outputs are achieved even with a low level of slag. Also, frequent switching of the transformer stage may be avoided.

“Additional substance with high ionizing energy” is understood in this case as an additional substance, the ionizing energy thereof being above 10 eV, in particular above 15 eV. This includes the noble gases and hydrogen-containing gases, such as for example propane. “Additional substance with low ionizing energy” is additionally understood as an additional substance, the ionizing energy thereof being below 10 eV, in particular below 8 eV. Additional substances with low ionizing energy are, for example, the alkali metals and aluminum as well as the metal salts thereof.

A process state of the melting process, in particular the actual process state, may be determined and the field strength (and/or the conductivity) of the plasma light arc is controlled according to the process state. “Process state” in this case is understood as the actual process state of the melting process. The melting process has different development phases in which the relationship between the solid material and liquid bath in the arc furnace varies so that the requirements for the arc are also variable. The determination of the actual process state of the melting process is thus the prerequisite for optimal control of the arc properties and thus for increasing the efficiency and/or output of the arc furnace. The current process state is detected, for example, via the introduced energy. In particular the thermal state of the arc furnace, the time sequence of the currents and the voltages as well as sound signals or structure-borne sound signals are used for a more accurate description of the melting process

In addition to the type of additional substance introduced, an adjustment of the plasma conditions and/or properties is also provided via the quantity of the at least one additional substance. The required quantity of the at least one additional substance introduced is substantially dependent on the arc volume and is thus proportional to the arc output. Therefore, the quantity of the additional substances introduced may be metered in the range of 0.1 to 50 m³/h per MW arc output, in particular in the range of 5 to 10 m³/h per MW arc output. An indirect control expediently takes place via the admission pressure P_{abs} of the system.

According to an embodiment, the additional substances are gaseous or present as an aerosol and are metered by controlling the gas pressure. The control of the gas flow in this case is based, in particular, on determining the process state, for example in the case of thermal stress of the furnace which is too high, corresponding measures are undertaken for controlling the plasma arc. Additionally or alternatively, for controlling the gas flow an operating diagram of the arc furnace which is based on empirical values may be present.

Advantageously, the at least one electrode is configured as a hollow electrode and the at least one additional substance is supplied via the electrode. If a supply of gas is integrated in a graphite electrode, this leads to the positive side effect that the injected gas cools the electrode and optionally even encases the electrode which reduces the electrode wear during the operation of the electrode. In the case of a graphite electrode, depending on the additional substance supplied, it may also lead to a reform reaction which due to its energy consumption also leads to the cooling of the electrode.

Alternatively or additionally to the hollow electrode, the additional substance is advantageously supplied into the arc furnace via injectors through a furnace wall or a furnace roof or the additional substances are injected via porous plugs on the base of the arc furnace. The separate supply devices or injectors on the furnace wall, on the furnace roof or on the furnace base, discharge in particular as close as possible to the electrode and thus to the plasma so that the additional substance is injected, in particular directly, into the plasma.

Also described is a signal processing device for an arc furnace having a machine-readable program code which has control commands which cause the signal processing device to carry out the method as in one of the above-described embodiments. The machine-readable program code has control commands which cause the signal processing device to carry out the method according to one of the above-described embodiments. The machine-readable program code may be stored on a storage medium.

Finally, the arc furnace, may be an electric arc furnace, having at least one electrode for melting a melting material by a plasma arc produced by the at least one electrode and having the above-mentioned signal processing device. The electrode in this case may be configured as a hollow electrode for the supply of additional substances. Moreover, injectors for the additional substances are expediently provided on a furnace wall or on a furnace roof or porous plugs for the injection of the additional substances are provided on the base of the arc furnace.

The increase in plasma conductivity and the delay of the recombination during scrap melting leads to a considerably more stable arc operation with substantially reduced current fluctuations and flicker values and to a sinusoidal current path. Similarly, the stable arc has a positive effect on the electrode wear.

### BRIEF DESCRIPTION OF THE DRAWINGS

These and other aspects and advantages will become more apparent and more readily appreciated from the following description of the exemplary embodiment, taken in conjunction with the accompanying drawings, in which:

FIG. 1 is a graph of a mode of operation of a known arc furnace,

FIG. 2 is a graph of an optimized mode of operation of an arc furnace with control of the plasma atmosphere, and

FIG. 3 is a block diagram of the control of the injection of an additional substance influencing the plasma composition.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

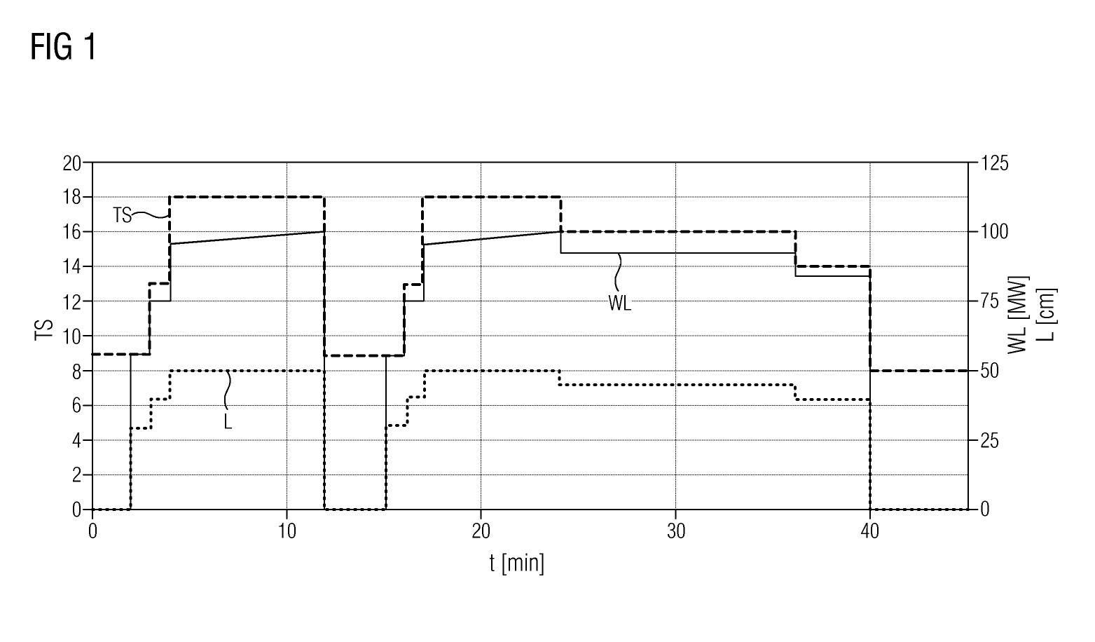

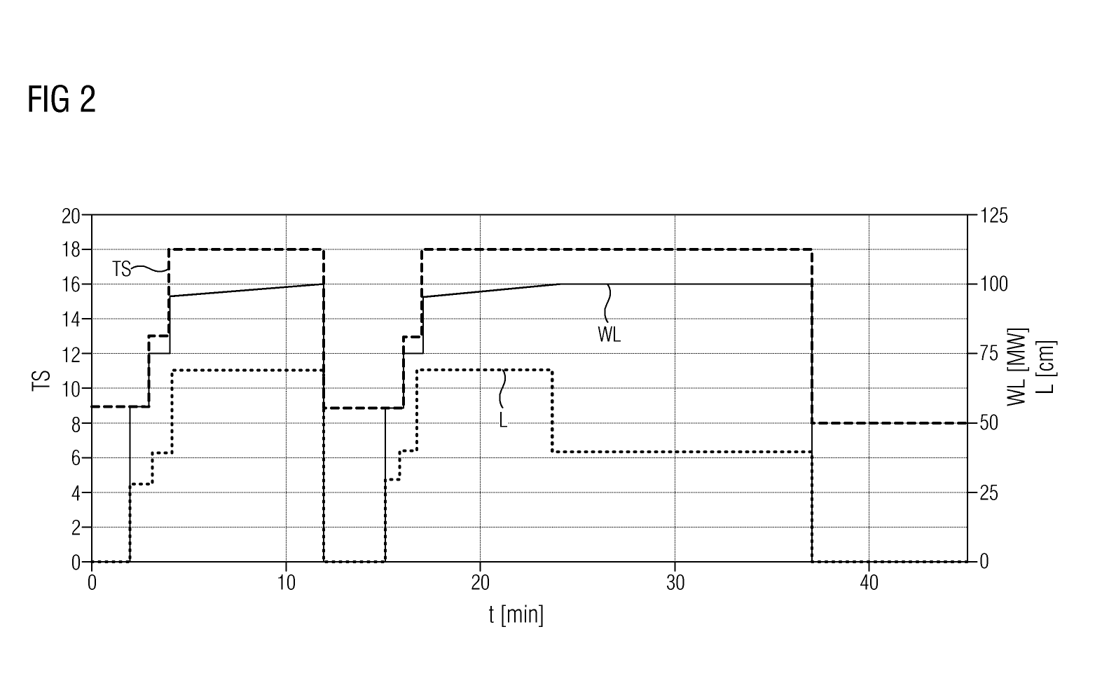

The path of the transformer stages TS, an effective power WL [MW] and an arc length L [cm] over time t [min], during operation of a known arc furnace (FIG. 1) and an arc furnace with plasma control via an additional substance (FIG. 2), is shown in FIGS. 1 and 2.

In both operating modes, the respective arc furnace, not shown here in more detail, is charged with a basket of solid melting material and started up. The arcs are ignited approximately during the 3rd minute. During the subsequent melting of the introduced material, the arcs burn in a relatively unstable manner due to the dynamics of the introduced material and the migration of the root. According to FIG. 2, therefore, an additional substance with high ionizing energy, such as for example an inert gas, hydrogen or methane is supplied to the plasma of the arc, so that the conductivity of the plasma is increased and/or its field strength is reduced. The length of the arc in this case reaches, in particular, approximately 70 cm, i.e. it is ca. 20 cm longer than the length of the arc in a conventionally operated arc furnace according to FIG. 1. The extended plasma arc melts the solid scrap in a greater volume than the arc according to FIG. 1. This results in a more efficient melting operation which has a lower energy requirement. Adapting the conductivity of the arc additionally has the advantage that the current fluctuations and, in particular, the flicker value are markedly reduced. By the provision of a suitable plasma atmosphere, moreover, a sinusoidal path of the arc current and arc voltage may be achieved. The klirr factor and/or the harmonics of the current are markedly reduced thereby. Accordingly, filter circuits may be dispensed with and/or the power supply network is not as heavily loaded.

Approximately 15 minutes after the start of the melting process, a second basket of scrap is supplied to the respective arc furnace. The arc is also lengthened for melting the second basket.

The solid material from the second basket has already been melted after approximately the 24th minute. So that not too much radiation is now discharged onto the furnace walls, according to FIG. 2 an adjustment is made to lower the conductivity and to shorten the arc length L, by an easily ionizable metal or metal salt, for example aluminum, calcium or potassium being introduced in the plasma arc. In this case, the radiation load may be reduced by ⅔ or a melt output which has been increased by 50% is achieved with the same radiation load. Additionally, by adapting the plasma, repeated switching of the transformer stages TS is avoided as may be derived from comparing FIGS. 1 and 2 in the area between the 24th and 37th minute. By comparing both figures it may also be seen that, in optimized operating mode, by adapting the plasma conductivity the melting process is shorter than in a conventionally operated arc furnace.

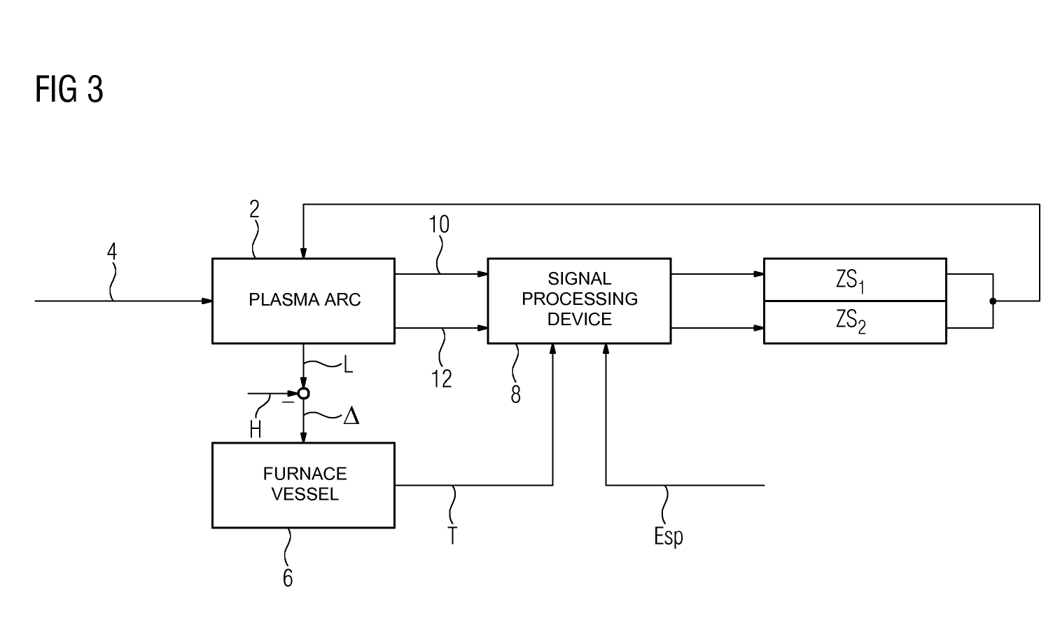

A block diagram for continuous control of the plasma composition in optimized operation of an arc furnace, not shown in more detail, is shown in FIG. 3. The control is based on determining a process state in the arc furnace, wherein the properties of the plasma, in particular its field strength, are adapted according to the process state.

The electrical operating point 4 which is predetermined by controlling the output of the arc furnace serves as an input variable of a plasma arc 2 produced in the arc furnace. Moreover, it is also significant which component Δ of the arc length L is not shielded by foaming slag or by the scrap pile. In this case, the height of the foaming slag is denoted by H. As this component Δ results in increased thermal load, the cool water temperatures T of the furnace vessel 6 may be used as a measurement thereof. The determined temperatures T are supplied together with the specific energy Eₛₚ introduced into the input material to a signal processing device 8.

At the same time as the determination of the thermal state of the arc furnace, structure-borne sound measurements and current measurements are carried out, the measurements directly providing information as to what extent the arcs are completely encased and the degree of stability of their combustion. The measurement signals 10, 12 of these measurements are also supplied to the control or regulating unit 8.

Depending on the input information, the quantity and the type of additional substance ZS₁, ZS₂ which is introduced into the arc 2 are calculated by the signal processing device 8. In this case, the quantity of additional substance ZS₁, ZS₂ is proportional to the output of the arc furnace. With a gaseous additional substance ZS₁, ZS₂, this is metered, in particular, via a gas pressure in the line for the additional substance ZS₁, ZS₂. The additional substance ZS₁, ZS₂ is introduced, in particular, via a hollow electrode of the arc furnace or alternatively supply devices or injectors may be provided on the walls, the roof or the base of the arc furnace.

When controlling the plasma composition via the additional substances ZS₁, ZS₂, it is generally the case that plasma with a high conductivity is required during scrap melting, in particular at the start of the melting process, thus an additional substance ZS₁ with low ionizing energy is supplied to the plasma and, with a substantially liquid bath in the arc furnace, in particular at the end of the melting process, the conductivity of the plasma is adjusted to be lower, by an additional substance ZS₂ with high ionizing energy being introduced into the arc.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-15. (canceled)

16. A method for operating an arc furnace having at least one electrode melting a material by a plasma arc produced by the at least one electrode, comprising:
controlling the plasma arc by introducing into the plasma at least one of a low ionizing substance, having low ionizing energy that influences a plasma composition and reduces a field strength of the plasma arc, and a high ionizing substance having high ionizing energy that influences the plasma composition and increases the field strength of the plasma arc.

17. The method as claimed in claim 16, wherein the low ionizing substance is selected from the group consisting of a metal and a metal salt.

18. The method as claimed in claim 16, wherein the high ionizing substance is an inert gas.

20. The method as claimed in claim 16, further comprising
determining a process state of the melting process; and
controlling the field strength of the plasma arc according to the process state.

21. The method as claimed in claim 20, wherein the high and low ionizing substances are introduced in a range of 0.1-50 m³/h per MW arc output.

22. The method as claimed in claim 21, wherein high and low ionizing substances are introduced in a range of 5-10 m³/h per MW arc output.

23. The method as claimed in claim 22, wherein introduction of the high and low ionizing substances is controlled based on an admission pressure.

24. The method as claimed in claim 23, wherein the high and low ionizing substances are at least one of gaseous and present in an aerosol and are metered by controlling gas pressure.

25. The method as claimed in claim 24, wherein the at least one electrode is hollow and the high and low ionizing substances are supplied via the electrode.

26. The method as claimed in claim 24, wherein the high and low ionizing substances are injected into the arc furnace via injectors through at least one of a furnace wall and a furnace roof.

27. The method as claimed in claim 24, wherein the high and low ionizing substances are injected via porous plugs on a base of the arc furnace.

28. The method as claimed in claim 16, wherein introduction of the high and low ionizing substances is controlled based on an admission pressure.

29. The method as claimed in claim 16, wherein the high and low ionizing substances are at least one of gaseous and present in an aerosol and are metered by controlling gas pressure.

30. The method as claimed in claim 16, wherein the at least one electrode is hollow and the high and low ionizing substances are supplied via the electrode.

31. The method as claimed in claim 16, wherein the high and low ionizing substances are injected into the arc furnace via injectors through at least one of a furnace wall and a furnace roof.

32. The method as claimed in claim 16, wherein the high and low ionizing substances are injected via porous plugs on a base of the arc furnace.

33. A signal processing device for an arc furnace having at least one electrode melting a material by a plasma arc produced by the at least one electrode, comprising:
a memory storing machine-readable program code with control commands; and
a processor executing the control commands that control the plasma arc by introducing into the plasma at least one of a low ionizing substance, having low ionizing energy that influences a plasma composition and reduces a field strength of the plasma arc, and a high ionizing substance having high ionizing energy that influences the plasma composition and increases the field strength of the plasma arc.

34. A non-transitory machine-readable medium storing program code with control commands that when executed by a signal processing device perform a method of controlling operation of an arc furnace having at least one electrode melting a material by a plasma arc produced by the at least one electrode, the method comprising:
controlling the plasma arc by introducing into the plasma at least one of a low ionizing substance, having low ionizing energy that influences a plasma composition and reduces a field strength of the plasma arc, and a high ionizing substance having high ionizing energy that influences the plasma composition and increases the field strength of the plasma arc.

35. An arc furnace melting a material by a plasma arc, comprising:
at least one electrode producing the plasma arc that melts the material; and
a signal processing device processor executing control commands that control the plasma arc by introducing into the plasma at least one of a low ionizing substance, having low ionizing energy that influences a plasma composition and reduces a field strength of the plasma arc, and a high ionizing substance having high ionizing energy that influences the plasma composition and increases the field strength of the plasma arc.

36. The arc furnace as claimed in claim 35, wherein the at least one electrode includes at least one hollow electrode supplying the high and low ionizing substances.

37. The arc furnace as claimed in claim 35, further comprising:
a furnace wall and a furnace roof; and
injectors, supplying the high and low ionizing substances, disposed on at least one of the furnace wall and the furnace roof.

38. The arc furnace as claimed in claim 35, further comprising:
a base of the arc furnace; and
porous plugs, supplying the high and low ionizing substances, disposed on the base of the arc furnace.
